(19) United States
(12) Patent Application Publication
(10) Pub. No.: US 2026/0048677 A1
(43) Pub. Date: Feb. 19, 2026

(54) CHARGING SYSTEM

(71) Applicant: TOYOTA JIDOSHA KABUSHIKI KAISHA, Toyota-shi (JP)

(72) Inventor: Taira Iraha, Okazaki-shi (JP)

(73) Assignee: TOYOTA JIDOSHA KABUSHIKI KAISHA, Toyota-shi (JP)

(21) Appl. No.: 19/194,208

(22) Filed: Apr. 30, 2025

(30) Foreign Application Priority Data
Aug. 19, 2024 (JP) 2024-137677

(51) Int. Cl. B60L 53/66; B60L 53/62

(52) U.S. Cl. CPC B60L 53/66; B60L 53/62; B60L 2250/12

(57) ABSTRACT

A charging system includes a controller including a simultaneous charging determination unit for determining that a plurality of power storage devices are connected; a priority request reception unit for accepting a request for charging a predetermined power storage device preferentially to another power storage device; a request announcement unit for notifying that a request has been made; a prioritized charging approval unit for approving preferential charging of a predetermined power storage device based on the request; a prioritized charging instruction unit for preferentially charging the predetermined power storage device preferentially to charging the other power storage device when approval is given; and a basic charging order setting unit for setting the order of charging of the plurality of power storage devices in the order in which the power storage device is connected to the charging station when there is no priority request and when there is no preferential charging approval.

### CROSS-REFERENCE TO RELATED APPLICATION

This application claims priority to Japanese Patent Application No. 2024-137677 filed on Aug. 19, 2024. The disclosure of the above-identified application, including the specification, drawings, and claims, is incorporated by reference herein in its entirety.

### BACKGROUND

### 1. Technical Field

The present disclosure relates to a system for charging a power storage device of an electrified vehicle or the like, and more particularly, to a system for controlling simultaneous charging of secondary batteries in a plurality of power storage devices.

### 2. Description of Related Art

A charging system that is configured to control charging of a plurality of vehicles equipped with power storage devices is described in Japanese Unexamined Patent Application Publication No. 2023-180747 (JP 2023-180747 A). In this system, the vehicles hold information for deciding a charging schedule, and based on the information, one of the vehicles decides a charging schedule including an order of performing charging. The charging schedule is a time of starting and ending the charging for each vehicle, or a charging order thereof, and is decided by referring to a State of Charge (SOC) of each vehicle, and limiting conditions of the power storage devices or the like.

### SUMMARY

In conjunction with the widespread use of electrified vehicles such as battery-powered battery electric vehicles (BEV) and plug-in hybrid electric vehicles (PHEV), various types of charging stations, which can be used by indeterminate vehicles, have been built. This type of charging station is provided with a plurality of charging cables or power outlets, such that a plurality of vehicles can be charged simultaneously. Though these vehicles have a point in common in that power storage devices are installed therein, capacities of the power storage devices, control systems for controlling the power storage devices, systems for performing data communication externally, applications installed therein, and so forth, are usually different from each other. Accordingly, multiple vehicles that are connected to the charging station do not necessarily share common information for charging. Also, information usually cannot be exchanged among vehicles, and accordingly creating the charging schedule described in JP 2023-180747 A is difficult.

Therefore, when multiple vehicles are charged at the same time in a charging station for a great number of indeterminate electrified vehicles, which vehicle will complete charging first is decided based on a state of the vehicle or the power storage device, and is a matter that is controlled by chance. For example, when charging of a vehicle is started first, but the SOC of a subsequent vehicle is great, or the subsequent vehicle is capable of rapid charging or super-rapid charging, charging of the subsequent vehicle will be completed earlier than the preceding vehicle is completed. On the other hand, when a condition that restricts charging is satisfied, such as the temperature of the power storage device being high, or the like, completion of charging may be slower than completion of charging of the other vehicles even though the necessary charging amount is small or rapid charging or super-rapid charging is enabled.

Conversely, completing charging in the order of connecting to the charging station is conceivable. In this case, making subsequent vehicles to wait for charging until charging of the preceding vehicle is completed would substantially make simultaneous charging non-implementable, and accordingly the primary function of the charging station that is capable of connecting multiple vehicles will be lost. From a different perspective, an arrangement is conceivable in which charging is performed at the same time, but the order of completion of charging is the order of connecting to the charging station. However, in this case, an inconvenience arises in which a certain vehicle should be able to complete charging in a short time, but the time required for charging is long due to being late in order to connect to the charging station.

From yet another perspective, an arrangement is conceivable in which the order of completion of charging of multiple vehicles, which are simultaneously connected to the charging station, depends on the SOC of each vehicle, the capacity of the power storage device thereof, and so forth. However, in such a configuration, there is an inconvenience in that a driver or an owner of a vehicle of which completion of charging is later than that of a subsequent vehicle may needlessly suspect that there is a malfunction, trouble, or the like, in his/her vehicle or in the charging station, due to the completion of charging being later than that of the other vehicle.

The above-described problem when charging is performed by connecting multiple power storage devices to the same charging station is caused by the fact that charging is performed in the absence of intent or cognizance of the person performing charging. Accordingly, it is an object of the present disclosure to resolve or reduce the suspicion or sensation that something is amiss, coming from simultaneous charging, by reflecting the intent of the parties involved when performing simultaneous charging, so to say.

In order to achieve the above object, the present disclosure provides a charging system that supplies external electric power to a plurality of power storage devices via a charging station to which the power storage devices are connected, so as to charge the power storage devices, the charging system including a controller that decides an order in which the power storage devices that are connected to the charging station are to be charged, in which
the controller includes
   a simultaneous charging determination unit that determines that multiple ones of the power storage devices are connected to the charging station, a priority request reception unit for receiving a request by a manual operation for charging a predetermined power storage device from among the power storage devices with priority over other power storage devices,
   a request announcement unit that announces that the request was received, a prioritized charging approval unit for approving prioritized charging for the predetermined power storage device based on the request, based on the manual operation,
   a prioritized charging instruction unit that, when the approval is made by the prioritized charging approval unit, performs charging of the predetermined power storage device with priority over charging of the other power storage devices, and
   a basic charging order setting unit that, when there is no such request received by the priority request reception unit and when there is no such approval by the prioritized charging approval unit, sets the order of charging of the power storage devices in the order in which the power storage devices were connected to the charging station.

In the present disclosure, the request that is received by the priority request reception unit may be a request to prioritize charging of a subsequent power storage device of which the order of being connected to the charging station was second or later, from among the power storage devices, over charging of a preceding power storage device that was connected to the charging station prior to the subsequent power storage device, and the request announcement unit may be configured to make the announcement to the preceding power storage device.

In the present disclosure, the controller further may include an information acquisition unit for acquiring information regarding the power storage device, and a request condition determination unit that determines a permission condition for enabling the request for performing charging with priority, in which the basic charging order setting unit may be further configured to set the order of charging of the power storage devices to the order in which the power storage devices were connected to the charging station, when the power storage device regarding which the information is acquired by the information acquisition unit does not satisfy the permission condition.

In the present disclosure, the controller may further include a continuous charging instruction unit that performs continuous charging of the other power storage devices at a lower electric power than charging electric power of the predetermined power storage device of which charging is prioritized, during charging of the predetermined power storage device.

According to the present disclosure, when multiple power storage devices are connected to a charging station, charging of the multiple power storage devices is executed in a so-called basic charging order, in the order of being connected to the charging station. Conversely, a request for charging one of the power storage devices with priority over another power storage device is made by a manual operation by an owner of one of the power storage devices, an occupant of a vehicle in which the power storage device is installed, or the like. When this is accepted, an announcement is made that the request has been made. This announcement may simply be displayed at the charging station, or may be made to a specific person, such as the owner of another power storage device that is simultaneously connected, or the like. When an operation for approval is performed based on the announcement, the prioritized charging instruction unit instructs charging of the predetermined power storage device with priority over other power storage devices. As a result, the power storage devices are charged in an order that is different from the so-called basic order. Even when charging is completed in an order different from the order of connection at the charging station, the charging is completed in an order that is understood by those who have manually performed the request or approval. Accordingly, suspicion that there is a malfunction, abnormality, or the like, in the charging station or the power storage device, and the sensation that something is amiss such as charging not being completed by the expected timing, can be circumvented or suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram schematically showing a configuration of an embodiment of the present disclosure;

FIG. 2 is a block diagram illustrating a functional configuration of the controller;

FIG. 3 is a flowchart for describing an example of control implemented in an embodiment of the present disclosure;

FIG. 4 is a flow chart for describing another exemplary control implemented in an embodiment of the present disclosure; and

FIG. 5 is a flowchart for explaining still another example of the control performed in the embodiment of the present disclosure.

### DETAILED DESCRIPTION OF EMBODIMENTS

Embodiments of the present disclosure will now be described with reference to the accompanying drawings. Note that the embodiments described below are merely examples of the implementation of the present disclosure, and are not intended to limit the present disclosure.

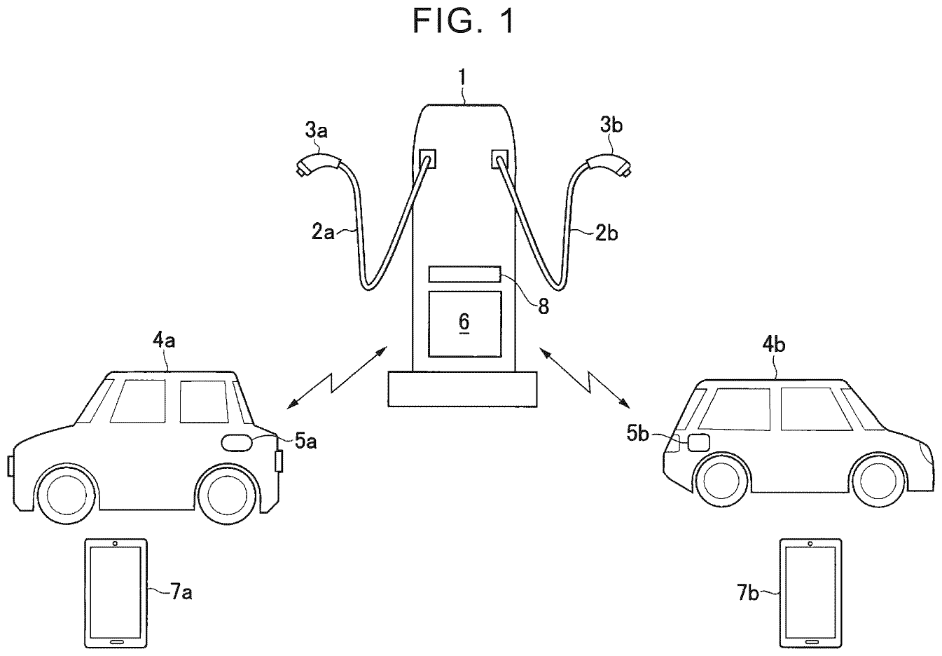

In the charging system according to the embodiment, external electric power is supplied from a charging station (also referred to as a charging station) to the power storage device to charge the power storage device. FIG. 1 conceptually illustrates an example of a charging system. The charging station 1 includes a predetermined power supply, and includes a plurality of (for example, two) charging cable 2a, 2b, and a connector 3a, 3b attached to each of the distal end portions. In the embodiment illustrated in FIG. 1, the power storage device is a power storage device 5a, 5b mainly including a secondary battery mounted on an electrified vehicle 4a, 4b such as a BEV or a PHEV. By connecting the connector 3a, 3b to a socket (not shown) provided on electrified vehicle 4a, 4b, the charging station 1 is connected to the power storage device 5a, 5b to perform charging.

The charging station 1 includes a controller 6. When electrified vehicle 4a, 4b is connected via the charging cable 2a, 2b, the charging station 1 is configured to acquire information about the power storage device 5a, 5b such as SOC of the power storage device 5a, 5b and the battery temperature. These pieces of information are used for calculating the possibility of charging, the charging electric power, the charging time, and the like, and charging is performed according to the result of the calculation based on the information. In addition, the charging time, the state of the charging, or the end of the charging is transmitted to electrified vehicle 4a, 4b or the passenger thereof as needed. The communication to the occupant may be performed on a mobile terminal 7a, 7b such as a smart phone, a smart watch, a laptop PC, or a tablet terminal. The communication to the occupant may be carried out directly to electrified vehicle 4a, 4b using a navigation-system or a VICS (Vehicle Information Communication System. These functions may be the same as those provided in a charging station known in the art.

The charging station 1 includes a communication device 8 for transmitting and receiving data to and from a separate device such as a mobile terminal 7a, 7b. The communication device 8 includes a communication I/F and is in data communication with the mobile terminal 7a, 7b by short-range communication such as the Internet-radio LAN (Local Area Network), NFC (Near Field Communication, or Bluetooth. In addition, depending on the content of the data to be transmitted and received, it may be configured to communicate with only one of the mobile terminal 7a (or 7b). The mobile terminal 7a, 7b is provided with an application that receives electric power from the charging station 1 and gives instructions on acquiring and charging control for charging the power storage device 5a, 5b. By the application, it is possible to display the charging status transmitted from the charging station 1, to receive and display a request for preferential charging, which will be described later, and to transmit approval/disapproval of the request.

The controllers 6 are mainly composed of a microcomputer composed of an arithmetic unit (CPU), a storage unit (RAM, ROM), various interfaces (I/F), and the like. The controller 6 performs an operation according to a predetermined program using data input from the outside or data stored in advance. The controller 6 is configured to output a result of the calculation as a control command signal. Basic control is control such as starting and ending of charging, charging electric power, counting of times required for charging, and the like when there is a charge request due to any one of the connector 3a, 3b described above being inserted into a connector of any electrified vehicle 4a, 4b. In the embodiment of the present disclosure, the controller 6 is further configured to perform control when a plurality of power storage devices 5a, 5b are connected to the charging station 1.

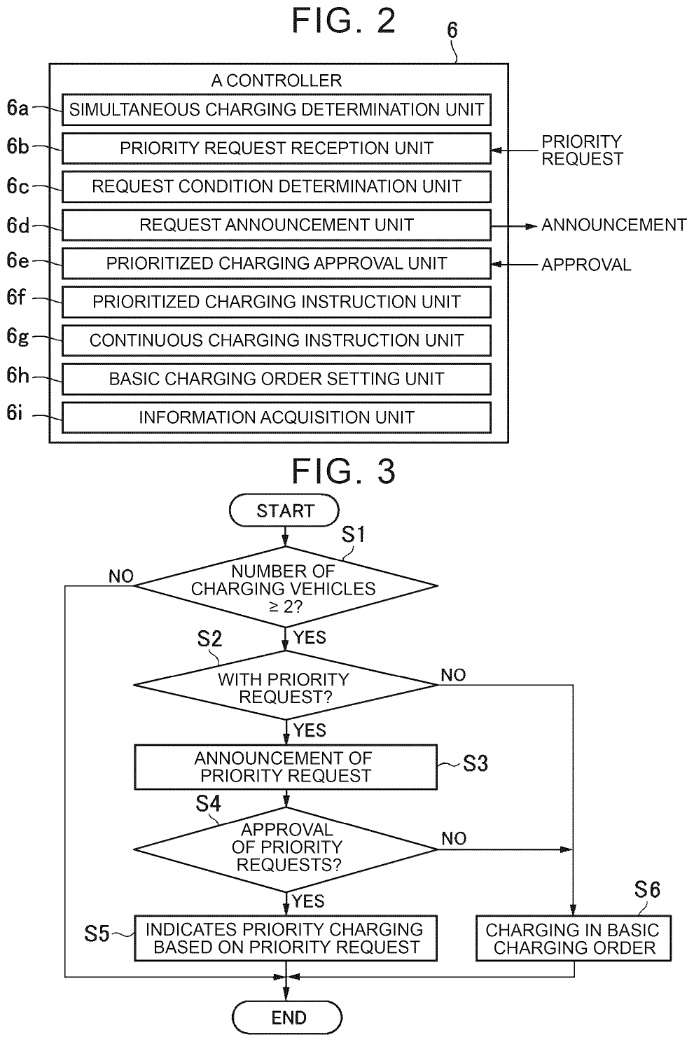

FIG. 2 is a block-diagram illustrating a configuration of the above-described controller 6 in order to perform so-called simultaneous charge control when a plurality of power storage device 5a, 5b are charged. The controller 6 includes a simultaneous charging determination unit 6a. The simultaneous charging determination unit 6a determines that a plurality of power storage devices 5a, 5b are connected to the charging station 1. This determination can be made, for example, based on a plurality of sensors outputting a detected signal by providing a sensor (not shown) in the connector 3a, 3b.

The controller 6 includes a priority request reception unit 6b. When a plurality of power storage devices 5a, 5b are connected to the charging station 1, a request for preferential charging, that is, a priority request can be made. This prioritization request can be performed by an occupant of electrified vehicle 4a, 4b on which the power storage device 5a, 5b is mounted, for example, by manually operating the mobile terminal 7a, 7b of the occupant. In order to be able to make the prioritization request, the occupant of electrified vehicle 4a, 4b on which the power storage device 5a, 5b are mounted is notified that a plurality of power storage devices 5a, 5b are connected to the charging station 1. It is possible to notify the occupant of this together with the information on the charging such as the start and end of the charging and the charging time. In addition, electrified vehicle 4a, 4b or the occupant notified to be capable of priority request for performing charging with priority may be limited to an electrified vehicle 4a, 4b equipped with the second and subsequent power storage device 5a, 5b or the occupant of the power storage device 5a, 5b connected at the same time. The second and subsequent power storage device 5a, 5b may be referred to as a subsequent power storage device.

Conditions may be provided for accepting the priority request. That is, the prioritization request is a request for the completion of the charging to be earlier than the other power storage device 5a, 5b, but when the charging takes a long time or the like, the charging efficiency of the charging station 1 as a whole is deteriorated. In addition, the passenger's patience or burden of electrified vehicle 4a, 4b on which the power storage device 5a, 5b is mounted is increased. The preceding power storage device may refer to 5a, 5b of the power storage device that has been turned back. In order to avoid such inconvenience, a restriction may be set in the acceptance of the priority request. The condition may be, for example, that a super-rapid charger having a high-voltage of several hundred volts is mounted on electrified vehicle 4a, 4b for which the preferential request is made, that the temperature of the power storage device 5a, 5b is equal to or lower than a predetermined upper limit temperature, and the like. A request condition determination unit 6c for determining whether such a condition is satisfied is provided in the controllers 6.

A request announcement unit 6d for notifying that a prioritized request has been received is provided in the controllers 6. This announcement may be made to electrified vehicle 4a, 4b or to the mobile terminal 7a, 7b of the occupant.

The controller 6 is provided with a prioritized charging approval unit 6e that approves the received priority request and approves the priority charge. The approval is based on the approval by the approval authorized person. The approval authorized person is a person who has connected the power storage device 5a, 5b to the charging station 1 before the person who has made the priority request, and a person who has been notified by the controllers 6 that the priority request has been made. This can be approved, for example, by manually operating the above-described mobile terminal 7a, 7b. The prioritized charging approval unit 6e approves the preferential charge by acquiring data based on a manual approval operation of the mobile terminal 7a, 7b.

The controllers 6 are provided with prioritized charging instruction unit 6f that instructs to perform priority charge based on the received priority request. The preferential charging is, for example, control of temporarily stopping the charging of the preceding power storage device 5a (or 5b) other than the subsequent power storage device 5a (or 5b) for which the preferential request has been made and giving priority to the charging of the subsequent power storage device 5a (or 5b) for which the preferential request has been made. Alternatively, the preferential charging is a control of making the charging electric power for the power storage device 5a (or 5b) that has been preferentially requested higher than the charging electric power of the other preceding power storage device 5b (or 5a).

Note that it is preferable that the charging of the preceding power storage device 5a, 5b in which the charging is delayed even if the charging station 1 is connected to the destination is continued while the above-described preferential charging is being performed. This is to maintain the coolant temperature at a predetermined temperature when the power storage device 5a, 5b is water-cooled. Therefore, the charging electric power is a low power obtained by an experiment, simulation, or the like as the electric power required for keeping the coolant warm. The controller 6 is provided with a continuous charging instruction unit 6g for instructing such so-called continuation charge.

A basic charging order setting unit 6h that controls so-called simultaneous charging when there is no prioritized request is provided in the controllers 6. The basic charging order when the plurality of power storage device 5a, 5b are connected to the charging station 1 is the connecting order to the charging station 1. The basic charging order setting unit 6h sets the charging order of the plurality of power storage devices 5a, 5b simultaneously connected to the charging station 1 to the connecting order to the charging station 1.

As described above, the order of charging of the plurality of power storage device 5a, 5b connected at the same time is determined based on information from the outside, such as the presence or absence of the prioritization request, the presence or absence of the approval, the charging capacity and the temperature of the power storage device 5a, 5b, and the like. An information acquisition unit 6i for acquiring such external information is provided in the controllers 6.

An example of the control by the controller 6 will be described with reference to a flowchart. FIG. 3 is a flow chart for explaining the first exemplary control, and first, it is determined whether or not the number of charged vehicles is equal to or greater than “2” in S1. Here, the charging vehicles are electrified vehicle 4a, 4b connected to the charging station 1, and in S1, it is determined whether or not a plurality of the charging stations are connected. The function of determining S1 is the function of the simultaneous charging determination unit 6a described above.

If the outcome of the determination in S1 is “yes”, S2 determines whether or not the above-described preferential charge is requested. The preference request is usually done by electrified vehicle (i.e., subsequent vehicle) 4a, 4b in the order connected to the charging station 1 from No. 2 onwards. In the embodiment illustrated in FIG. 1 described above, the prioritization request is performed by manually operating the mobile terminal 7a, 7b. When there is a priority request, that is, when the priority request is accepted by the priority request reception unit 6b described above, S2 determination is “yes”.

When the priority request is accepted and the determination result of S2 is “yes”, S3 proceeds, and the notification that the priority request has been made is performed by the request announcement unit 6d described above. Basically, this announcement is made to a so-called preceding vehicle in which the order of connecting to the charging station 1 is electrified vehicle 4a, 4b in which the prioritization is requested, i.e., the order of connecting to the charging station 1 is first, or the passenger thereof. Further, the announcement is performed by displaying the notification on a monitor (not shown) mounted on electrified vehicle 4a, 4b or a mobile terminal 7a, 7b held by the occupant, for example. In order to notify that the priority request has been accepted, the above announcement may also be made to the person who has made the priority request.

In a subsequent S4, it is determined whether the prioritization request has been approved. The authorized person that approves is a person who connects the preceding vehicle to the charging station 1, such as an occupant or an owner of the subsequent vehicle. Since announcement is made to the authorized person that a prioritization request has been made, for example, an icon displayed on a mobile terminal 7a, 7b or an in-vehicle touch panel (not shown) is manually operated (touched) as a response to the announcement, so that an approval signal is inputted to the controller 6.

The approval signal is received by the prioritized charging approval unit 6e described above, and if the result of the determination in S4 is “yes” based on the acknowledgement signal, a charge based on the priority request, that is, the priority charge is instructed in S5. The function of this S5 is the function of the prioritized charging instruction unit 6f described above. After the control of S5 is executed, the series of routines shown in FIG. 3 is temporarily ended.

The priority charging is a control for completing the charging of the power storage device 5a, 5b in the subsequent vehicle, which has made the priority request, before the charging of the power storage device 5a, 5b of the preceding vehicle. The charging may be performed in various ways, for example, by temporarily stopping the charging of the preceding vehicle and performing the charging of the subsequent vehicle. Alternatively, the charging electric power for the preceding vehicle may be decreased and the charging electric power for the subsequent vehicle may be increased. Further, the charging for the preceding vehicle and the charging for the subsequent vehicle may be alternately performed, and the charging electric power for the subsequent vehicle may be increased, or the charging time per time may be increased.

Note that, although the plurality of power storage devices 5a, 5b are connected to the charging station 1, when the determination result of S2 is “no” due to the absence of the above-described priority request, and when the determination result of S4 is “no” due to the non-approval of the priority request, charging of the power storage devices 5a, 5b in the basic charging order proceeds to S6, and thereafter, the routine of FIG. 3 is temporarily ended. Here, the basic charging order is an order in which the power storage device 5a, 5b is connected to the charging station 1, and the power storage device 5a, 5b that is previously connected to the charging station 1 is charged preceding with respect to the other power storage device 5a, 5b, and the charging is completed. In this case, the charging of the power storage device 5a, 5b in the preceding electrified vehicle 4a, 4b may be completed first even when SOC of the power storage device 5a, 5b in the subsequent electrified vehicle 4a, 4b is high and full charging is reached in a short time. The function of this S6 is the function of the basic charging order setting unit 6h described above.

When electrified vehicle 4a, 4b (or the power storage device 5a, 5b) connected to the charging station 1 is one and S1 is determined to be “no”, the routine of FIG. 3 is temporarily ended without performing any particular control. That is, the charging is executed without performing control for determining the order of charging.

Therefore, according to the charging system of the above-described embodiment, the precedence order of charging the power storage device 5a, 5b connected to the charging station 1 is the order agreed between the parties involved in the simultaneous charging. That is, since the completion of the charging is not delayed contrary to the intention of the parties, it is possible to avoid doubts such as a charging abnormality or a failure of the device based on the timing of the completion of the charging, or a sense of discomfort.

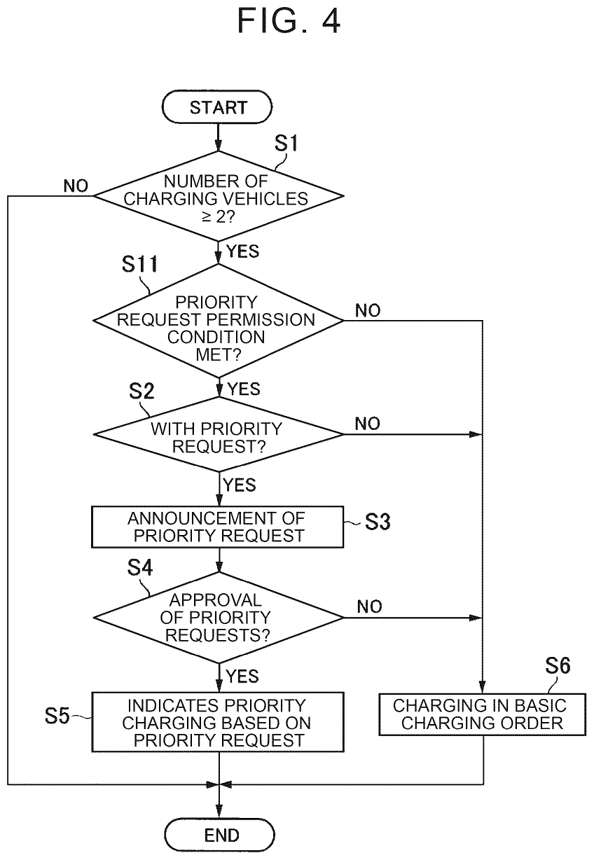

Another example of control that can be performed in an embodiment of the present disclosure will be described with reference to a flowchart shown in FIG. 4. The control example illustrated in FIG. 4 is an example in which a condition is set to request for preferential charging or to accept a preferential request. Therefore, the routine shown in FIG. 4 is provided with a S11 for determining whether the priority-request permission condition is satisfied, and the other control steps are the same as those in the control example shown in FIG. 3. That is, in FIG. 4, when S1 determination is “yes”, the process proceeds to S11, and whether or not the preferential request permission condition is satisfied is determined by the above-described request condition determination unit 6c. The priority-request permission condition is basically a condition in which an expectation that the time required for the completion of the charging is shorter than the charging time required by the other power storage device 5a, 5b connected to the charging station 1 at the same time is satisfied.

An example of this condition is the ability to charge very rapidly at hundreds of volts, and the higher SOC leads to a full charge in a short period of time. On the contrary, it is possible to set a priority-request permission condition that the power storage device 5a, 5b is not in a state of restricting charge such as an excessively high temperature.

When the determination result of S11 is “yes”, the process proceeds to the above-described S2, and the control of S2 or S5 is executed. On the contrary, when S11 is “no”, the priority request is not accepted or the charge based on the priority request is not performed, and thus the above-described S6 is performed.

Therefore, according to the control example illustrated in FIG. 4, it is possible to avoid or suppress occurrence of a situation that is contrary to a situation assumed by preferential charging, for example, a long time is required for preferential charging.

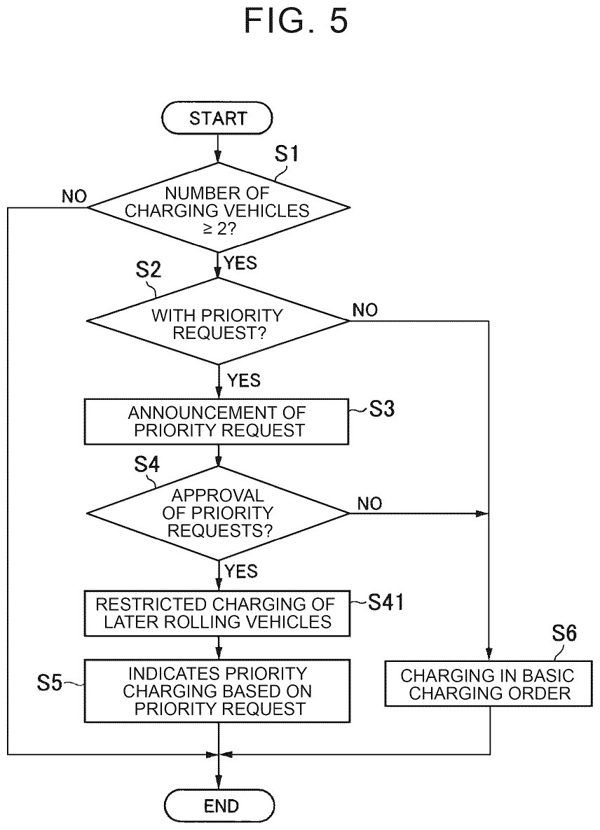

Further, the control example illustrated in FIG. 5 is an example in which a measure is added to electrified vehicle (preceding vehicle) 4a, 4b or the power storage device (preceding power storage device) 5a, 5b in which the charge is performed later. That is, when the charging station 1 has a capacity capable of simultaneously charging a plurality of power storage device 5a, 5b, there is no particular factor limiting the charging of the other power storage device 5a, 5b while the charging of any one of the power storage device 5a, 5b is prioritized. The charging station 1 can charge the other power storage device 5a, 5b to the extent that the so-called preferential charging is not hindered. Therefore, in the control illustrated in FIG. 5, as a measure relating to charging of the power storage device 5a, 5b which is to be turned backward, restricted charging of the backward-turning vehicles is performed. This control can be performed by the above-described continuous charging instruction unit 6g.

Specifically, the control example shown in FIG. 5 is an example in which the control example shown in FIG. 3 is added with a S41 for instructing the restricted charge of the subsequent vehicles, and therefore, the control steps other than S41 are the same as the control example shown in FIG. 3. That is, in the control example illustrated in FIG. 5, when the prioritization request is approved and the determination of S4 is “yes”, the limited charge of the vehicle is executed by S41 and thereafter, the process proceeds to S5.

Here, the restricted charging of the backward-running vehicles means charging that takes longer than the charging alone, such as charging with a lower charging electric power or intermittent charging with a long interval, without completely stopping the charging for electrified vehicle 4a, 4b in which the priority request is approved and the order of charging (or the order of charging completion) is delayed. In particular, it is preferable that the charging be a charging that supplies electric power to the extent that the temperature of the coolant temperature or the like of the power storage device 5a, 5b can be maintained by the heat generation caused by the charging. By doing so, it is possible to avoid inconveniences such as a decrease in the temperature or a decrease in SOC in the power storage device 5a, 5b in which the charging is restricted by the charging associated with the prioritization request, and to reduce the load of the power cycle.

Note that the present disclosure is not limited to the above-described embodiment, and the number of power storage devices that can be simultaneously connected to the charging station may be three or more. In the case of three or more units, a plurality of priority requests may be accepted, and the charging order of the plurality of units may be determined collectively. In addition, the charging station may be either a stand of a type that charges the power storage device by alternating current or a stand of a type that charges the power storage device by direct current. Further, since the priority request may be configured to be performed by a manual operation, the priority request may be made by a switch provided in the charging station in addition to the portable terminal, the in-vehicle touch panel, or the like, and the approval may be made. The announcement that the priority request has been made is the same, and the announcement may be made by displaying the notification on the charging station. Furthermore, the permission conditions for enabling a request to perform charging preferentially in the present disclosure may be appropriately set as necessary. Still further, the controller in the present disclosure may be configured as cloud computing using an external server instead of being provided in a charging station.

What is claimed is:

1. A charging system that supplies external electric power to a plurality of power storage devices via a charging station to which the power storage devices are connected, so as to charge the power storage devices, the charging system comprising a controller that decides an order in which the power storage devices that are connected to the charging station are to be charged, wherein
the controller includes
a simultaneous charging determination unit that determines that multiple ones of the power storage devices are connected to the charging station,
a priority request reception unit for receiving a request by a manual operation for charging a predetermined power storage device from among the power storage devices with priority over other power storage devices,
a request announcement unit that announces that the request was received,
a prioritized charging approval unit for approving prioritized charging for the predetermined power storage device based on the request, based on the manual operation,
a prioritized charging instruction unit that, when the approval is made by the prioritized charging approval unit, performs charging of the predetermined power storage device with priority over charging of the other power storage devices, and
a basic charging order setting unit that, when the request is not received by the priority request reception unit and when the approval is not made by the prioritized charging approval unit, sets the order of charging of the power storage devices in the order in which the power storage devices were connected to the charging station.

2. The charging system according to claim 1, wherein
the request that is received by the priority request reception unit is a request to prioritize charging of a subsequent power storage device of which the order of being connected to the charging station was second or later, from among the power storage devices, over charging of a preceding power storage device that was connected to the charging station prior to the subsequent power storage device, and
the request announcement unit is configured to make the announcement to the preceding power storage device.

3. The charging system according to claim 1, wherein
the controller further includes
an information acquisition unit for acquiring information regarding the power storage device, and
a request condition determination unit that determines a permission condition for enabling the request for performing charging with priority, wherein
the basic charging order setting unit is further configured to set the order of charging of the power storage devices to the order in which the power storage devices were connected to the charging station, when the power storage device regarding which the information is acquired by the information acquisition unit does not satisfy the permission condition.

4. The charging system according to claim 3, wherein the controller further includes a continuous charging instruction unit that performs continuous charging of the other power storage devices at a lower electric power than charging electric power of the predetermined power storage device of which charging is prioritized, during charging of the predetermined power storage device.

5. The charging system according to claim 1, wherein the controller further includes a continuous charging instruction unit that performs continuous charging of the other power storage devices at a lower electric power than charging electric power of the predetermined power storage device of which charging is prioritized, during charging of the predetermined power storage device.
